(19) United States
(12) Patent Application Publication
(10) Pub. No.: US 2003/0080902 A1
(43) Pub. Date: May 1, 2003

(54) Method of obtaining timing information and methods of ranging using said timing information

(75) Inventor: David K. Roberts, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/252,499

(22) Filed: Sep. 23, 2002

(30) Foreign Application Priority Data
Oct. 25, 2001 (GB) 0125600.7

(51) Int. Cl. G01S 1/24; G01S 13/08

(52) U.S. Cl. 342/387; 342/118

(57) ABSTRACT

A method of obtaining timing information between first MS and second BS devices is discloses together with methods of ranging using said timing information and devices for the same. The method of obtaining timing information comprising the steps of transmitting a timing signal from the first device MS to the second device BS at a time t1 relative to the local clock of the first device MS and measuring the time of arrival t2 of that signal at the BS second device relative to the local clock of the second device BS; transmitting a timing signal from the second device BS to the first device MS at a time t3 relative to the local clock of the second device BS and measuring the time of arrival t4 of that signal at the first device MS relative to the local clock of the first device MS; and assembling the values of t1, t2, t3 and t4 in one of the devices.

### FIELD OF INVENTION

This invention relates to a method of obtaining timing information between first and second devices and to methods of ranging between the two devices using said timing information.

In particular, the invention relates to a method of obtaining timing information comprising the steps of transmitting a timing signal from the first device to the second device at a time t1 relative to the local clock of the first device and measuring the time of arrival t2 of that signal at the second device relative to the local clock of the second device; and transmitting a timing signal from the second device to the first device at a time t3 relative to the local clock of the second device and measuring the time of arrival t4 of that signal at the first device relative to the local clock of the first device.

### BACKGROUND TO INVENTION

Such a method is known from the section “Protocols for co-operating localizers to determine range” of the report entitled “Low-Power, Miniature, Distributed Position Location and Communication Devices Using Ultra-Wideband, Nonsinusoidal Communication Technology” prepared by ther Wire & Location Inc. for the US Advanced Research Projects Agency/Federal Bureau of Investigation (Contract J-FBI-94-058) in July 1995. At the time of writing, this report is available from the website of ther Wire & Location Inc. at url http://www.aetherwire.com/PI _Report_{—}95/pi_rep95.html.

In this report, a method of ranging between two devices is suggested in which timing information is obtained as above, and then the second device transmits the difference (Δtime) between t2 and t3 to the first device. The first device is then able to determine the range r between the two devices as:

$$r = \frac{c}{2} ( t4 - t1 - Δtime )$$

where c is the speed of light. In effect, the range is determined as a function of the round trip delay less the time elapsed between the second device receiving a timing signal and transmitting a return timing signal.

### OBJECT OF INVENTION

It is an object of the present invention to provide an alternative and improved method of obtaining timing information as described above with which the timing information obtaining can be readily used for, amongst other purposes, quantifying the lack of synchronicity and ranging between the two devices.

### SUMMARY OF INVENTION

In accordance with the present invention, such a method is provided in which the values of t1, t2, t3 and t4 are assembled together, ideally in one of the two devices although conceivable in a third device. In the case of the former, this may be done by transmitting values t2 and t3 from the second device to the first device and where this is the case, the values t2 and t3 may be transmitted in the timing signal transmitted at a time t3. Alternatively, the values t1, t2, t3 and t4 may be assembled in the second device by transmitting values t1 and t4 from the second device to the first device.

In either case, the difference between the local clocks (ΔClock) of the two devices, the lack of synchronicity, may be readily determined in one of the devices using the values of t1, t2, t3 and t4. For example:

$$ΔClock = \frac{t1 - t2 - t3 + t4}{2}$$

Further in accordance with the present invention, the range r between the two devices may be readily determined in one of the devices using the values of t1, t2, t3 and t4. For example, the range may be determined as:

$$r = \frac{c}{2} ( t4 - t1 - t3 + t2 )$$

where c is the speed of light

Alternatively, after determining the difference between the local clocks (ΔClock), the range r may be determined by transmitting a further timing signal from one of the devices at a time t5 relative to the local clock of that device and measuring the time of arrival t6 of that signal at the other device relative to the local clock of that device; and determining the range r between the two devices using the values of t5, t6 and ΔClock. In this case, the range r may be determined as:

$$r = \frac{c}{2} ( t6 - t5 - ΔClock )$$

and, again, optionally transmitted to the other device.

Also provided in accordance with the present invention is a corresponding combination of first and second devices as claimed in claims 14 to 16, and corresponding devices in isolation as claimed in claims 17 to 29.

### BRIEF DESCRIPTION OF DRAWINGS

The present invention will now be described, by way of example only, with reference to following figures in which:

FIGS. 1 and 2 show, schematically, a mobile cellular telephone MS ranging with to a nearby cellular telephone network base station BS.

### DETAILED DESCRIPTION

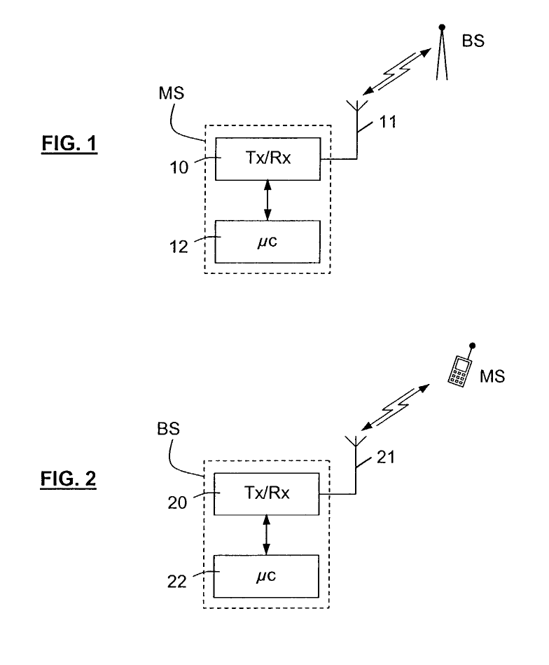

FIG. 1 shows, schematically, a mobile cellular telephone MS in accordance with the present invention and registered with a nearby cellular telephone network base station BS facilitating voice and data communication with that base station and the corresponding cellular telephone network (not shown). Such data communication may include text messaging using, for example, the short message service (SMS) protocol and accessing the internet using, for example, the wireless application protocol (WAP). The telephone is shown comprising a communications transmitter (Tx) and receiver (Rx) 10 connected to a communications antenna 11 and controlled by a communications microprocessor (μc) 12.

FIG. 2 shows, schematically, the base station BS with which the telephone MS of FIG. 1 is registered. The base station also comprising a communications transmitter (Tx) and receiver (Rx) 20 connected to a communications antenna 21 and controlled by a communications microprocessor (μc) 22.

As the design and manufacture of such telephones and base stations for two-way communication within a cellular telephone network are well known, those parts which do not directly relate to the present invention will not be elaborated upon here further.

As is known, in the event of the user of mobile cellular telephone MS making an emergency call, a position fix may be determined in the mobile cellular telephone and transmitted from mobile cellular telephone MS back to the base station and then on to the emergency services operator, termed the Public Safety Answer Point (PSAP) in the US. In order to obtain a position fix, the mobile telephone MS must range to at least 3 base stations of known location (only 1 shown).

In accordance with the present invention, each range r is obtained as described in steps described below:

telephone MS transmits a signal to base station BS at a time t1 relative to the telephone's local clock

base station BS measures the time of arrival t2 of the signal transmitted by telephone MS relative to the base station's local clock

base station BS transmits a signal to telephone MS at a time t3 relative to the base station's local clock wherein the signal comprises the values of t2 and t3

telephone MS measures the time of arrival t4 of the signal transmitted by base station BS relative to the telephone's local clock and extracts from the signal values of t2 and t3; and

telephone MS calculates its range to basestation BS as:

$$r = \frac{c}{2} ( t4 - t1 - t3 + t2 )$$

where c is the speed of light

Ideally, times t1, t2, t3 and t4 are measured to nanosecond resolution if ranging within a few meters is to be done. Telephone MS may also calculate the difference (ΔClock) between the local clocks of the telephone and base station as:

$$ΔClock = \frac{t1 - t2 - t3 + t4}{2}$$

which enables telephone MS to make future measurements of range by receiving only a signal from base station BS, until the difference between clocks of the telephone and base station drifts as described above. This difference may be transmitted to the base station.

Once 3 ranges have been obtained, the distances are resolved with the known positions of the base stations and a position fix determined. Of course, ranging to more than three base stations results in an overdetermined set of equations which can be resolved by a best fit type, iterative method to provide a position fix with improved accuracy and tolerance to error. Also, the first timing signal transmitted by the telephone MS may be received and measured by all three base stations.

This position fix is then transmitted to the base station with which the telephone is registered for the purposes of voice and data communication, and subsequently forwarded onwards to the emergency services operator thereby enabling the user of the telephone to receive prompt, location specific assistance.

Whilst the method of the present invention has been described with reference ranging in a cellular telephone context, it will be appreciated that this could have applied to other devices such as those that might be present in an in-home network or a local, say factory based positioning system.

Also, specific methods for measuring the time of transmission and reception of timing signals are well known and have not been greatly elaborated on in this disclosure. However, it is noteworthy that delays may occur in the transmitter and receiver owing to filters, delays with A to D converters etc. which will appear as part of the time-of-flight measurement and it may be necessary to measure these delays to remove them (for example, by factory calibration). If the delays transmitting from one device and receiving by another are the same the other way around, then the equations for ΔClock will still be valid although the values obtained for range r are strictly speaking pseudoranges until these delays have been subtracted.

1. A method of obtaining timing information between first and second devices comprising the steps of:
transmitting a timing signal from the first device to the second device at a time t1 relative to the local clock of the first device and measuring the time of arrival t2 of that signal at the second device relative to the local clock of the second device;
transmitting a timing signal from the second device to the first device at a time t3 relative to the local clock of the second device and measuring the time of arrival t4 of that signal at the first device relative to the local clock of the first device; and
assembling the values of t1, t2, t3 and t4 in a single device.

2. A method accordingly to claim 1 wherein the values t1, t2, t3 and t4 are assembled in the first device by transmitting values t2 and t3 from the second device to the first device.

3. A method according to claim 2 wherein the values t2 and t3 are transmitted from the second device to the first device in the timing signal transmitted at a time t3.

4. A method according to claim 1 wherein the values t1, t2, t3 and t4 are assembled in the second device by transmitting values t1 and t4 from the second device to the first device.

5. A method according to claim 1 further comprising the step of determining, using one of the devices, the difference between the local clocks (ΔClock) of the two devices using the values of t1, t2, t3 and t4.

6. A method according to claim 5 wherein the difference between the local clocks (ΔClock) is determined as:
$$ΔClock = \frac{t1 - t2 - t3 + t4}{2}$$

7. A method according to claim 5 wherein the difference between the local clocks (ΔClock) determined by one of the devices is transmitted to the other device.

8. A method of ranging between first and second devices comprising the steps of:
obtaining timing information between the two devices by a method according to claim 1; and
determining, using one of the devices, the range r between the two devices using the values of t1, t2, t3 and t4.

9. A method according to claim 8 wherein the range r is determined as:
$$r = \frac{c}{2} ( t4 - t1 - t3 + t2 )$$
where c is the speed of light.

10. A method according to claim 8 wherein the range r is determined by one of the devices and transmitted to the other device.

11. A method of ranging between first and second devices comprising the steps of:
obtaining timing information relating to the difference between the local clocks (ΔClock) of the two devices by a method according to claim 5;
transmitting a further timing signal from one of the devices at a time t5 relative to the local clock of that device and measuring the time of arrival t6 of that signal at the other device relative to the local clock of that device; and
determining the range r between the two devices using the values of t5, t6 and ΔClock.

12. A method according to claim 11 wherein the range r is determined as:
$$r = \frac{c}{2} ( t6 - t5 - ΔClock )$$
where c is the speed of light.

13. A method according to claim 11 wherein the range r is determined by one of the devices and transmitted to the other device.

14. A combination of first and second devices, each of which is adapted for two way communication with the other and has a local clock which is unsynchronized with respect to the other wherein the combination of devices are mutually adapted to obtain timing information between each other by a method in accordance with claim 1.

15. A combination of first and second devices, each of which is adapted for two way communication with the other and has a local clock which is unsynchronized with respect to the other wherein the combination of devices are mutually adapted to range between each other by a method in accordance with claim 8.

16. A combination of first and second devices, each of which is adapted for two way communication with the other and has a local clock which is unsynchronized with respect to the other wherein the combination of devices are mutually adapted to range between each other by a method in accordance with claim 11.

17. A device comprising a transmitter, receiver and processor adapted to receive and measure the time of arrival t1 relative to its local clock of a timing signal transmitted by another device; to transmit at a time t4 relative to its local clock a timing signal to the other device; and to transmit values t1 and t4 to the other device.

18. A device according to claim 17 wherein the device is adapted to transmit its timing signal only after receiving the other timing signal.

19. A device according to claim 18 wherein the timing signal transmitted by the device contains the values of t1 and t4.

20. A device adapted comprising a transmitter, receiver and processor adapted to transmit at a time t1 relative to its local clock a timing signal to another device; to receive and measure the time of arrival t4 relative to its local clock of a timing signal transmitted by the other device; and to receive and store values from the other device which are relative to the local clock of the other device and correspond to the time of arrival t2 at the other device of the timing signal transmitted at time t1 and to the time of transmission t3 at the other device of the timing signal received at time t4.

21. A device according to claim 20 wherein the timing signal received by the device contains the values of t2 and t3.

22. A device according to claim 20 further adapted to determine the difference between its local clock and the local clock of the other device (ΔClock) using the values of t1, t4, t2 and t3.

23. A device according to claim 22 wherein the difference between the local clocks (ΔClock) is determined as:
$$ΔClock = \frac{t1 - t2 - t3 + t4}{2}$$

24. A device according to claim 22 wherein the difference between the local clocks (ΔClock) is transmitted to the other device.

25. A device according to any of claims 20 further adapted to determine the range r to the other device using the values of t1, t4, t2 and t3.

26. A device according to claim 25 wherein the range r is determined as:
$$r = \frac{c}{2} ( t4 - t1 - t3 + t2 )$$
where c is the speed of light.

27. A device according to claim 22 further adapted to receive and measure the time of arrival t6 relative to its local clock of a further timing signal transmitted by the other device; to receive and store a value from the other device which is relative to the local clock of the other device and corresponds to the time of transmission t5 at the other device of that further timing signal; and to determine the range r to the other device using the values of t5, t6 and ΔClock.

28. A device according to claim 27 wherein the range r is determined as:
$$r = \frac{c}{2} ( t6 - t5 - Δ Clock )$$
where c is the speed of light.

29. A device according to any of claims 25 wherein the range r is transmitted to the other device.
